(19) United States
(12) Patent Application Publication
(10) Pub. No.: US 2007/0224964 A1
(43) Pub. Date: Sep. 27, 2007

(54) SUB-HARMONIC FREQUENCY CONVERSION DEVICE

(75) Inventors: Yong IL KWON, GYEONGGI-DO (KR); Myeung Su KIM, GYEONGGI-DO (KR); Joon Hyung LIM, GYEONGGI-DO (KR); Tah Joon PARK, GYEONGGI-DO (KR); Jin Ho KO, DAEJEON (KR); Sang Hyun CHO, DAEJEON (KR); Jong Moon KIM, DAEJEON (KR)

Correspondence Address: LOWE HAUPTMAN BERNER, LLP, 1700 DIAGONAL ROAD, SUITE 300, ALEXANDRIA, VA, 22314, US

(73) Assignees: SAMSUNG ELECTRO-MECHANICS CO., LTD., GYUNGGI-DO (KR); PHYCHIPS INC., DAEJEON (KR)

(21) Appl. No.: 11/617,583

(22) Filed: Dec. 28, 2006

(30) Foreign Application Priority Data
Mar. 22, 2006 (KR) 10-2006-0026144

(51) Int. Cl. H04B 1/26

(52) U.S. Cl. 455/326

(57) ABSTRACT

A sub-harmonic frequency conversion device includes: a voltage controlled oscillator for generating first to eighth oscillation frequency (LO) signals having a constant phase difference; a first mixer for performing a switching operation to mix the first to fourth LO signals having a phase difference of 90° and input signals, and outputting first IF signals; and a second mixer for performing a switching operation to mix the fifth to eighth LO signals having a phase difference of 90° and the input signals, and outputting second IF signals. Accordingly, the sub-harmonic frequency conversion device can use the low-frequency LO signal, and the power consumption can be reduced. In addition, because the mixers are implemented using a symmetric structure of the MOS transistors, the circuit configuration can be easily implemented.

### CROSS-REFERENCE TO RELATED APPLICATIONS

This application claims the benefit of Korean Patent Application No. 10-2006-0026144 filed with the Korea Intellectual Property Office on Mar. 22, 2006, the disclosure of which is incorporated herein by reference.

### BACKGROUND OF THE INVENTION

1. Field of the Invention

The present invention relates to a harmonic frequency conversion device, and more particularly, to a harmonic frequency conversion device which can use a low-frequency LO signal such that the power consumption can be reduced. In addition, because the mixers are implemented using a symmetric structure of the MOS transistors, the circuit configuration can be easily implemented.

2. Description of the Related Art

Recently, as the utility of wireless communications increases, wired/wireless integrated networks have been established in various fields. Thus, there is a demand for a wireless communication field that has a low-speed, low-cost and low-power technical standard.

Accordingly, a frequency conversion device of a wireless communication receiver has been developed to reduce power consumption and to lessen the number of elements mounted on a chip.

FIGS. 1 and 2 are waveform diagrams illustrating a process of generating an oscillation frequency (LO) signal according to the related art.

Referring to FIG. 1, an LO signal is generated by performing an Exclusive-OR operation on two signals i and q provided from a voltage control oscillator (VCO) (not shown). The two signals i and q have half the frequency of the LO signal.

Referring to FIG. 2, a multiplier 201 multiplies a signal s provided from a VCO (not shown) to generate an LO signal.

FIG. 3 is a schematic diagram of a conventional frequency conversion device using the LO signal shown in FIG. 1 or 2. Referring to FIG. 3, the conventional frequency conversion device outputs frequency-converted IF signals V_{OUT+} and V_{OUT-} by on/off switching an input signal V_{IN} according to the LO signal of FIG. 1 or 2 and another LO signal having a phase difference of 180° with respect to the LO signal.

However, the frequency conversion device using the LO signal of FIG. 1 has a problem in that a circuit configuration becomes complex due to the addition of the Exclusive-OR logic circuit.

In addition, the frequency conversion device using the LO signal of FIG. 2 has a problem in that a circuit configuration becomes complex and the power consumption increases due to the addition of the multiplier.

### SUMMARY OF THE INVENTION

An advantage of the present invention is that it provides a frequency conversion device that can use a low-frequency LO signal because it is implemented using the sub-harmonic scheme. In the frequency conversion device, a small-sized VCO can be used and the power consumption can be reduced because a multiplier is unnecessary.

Another advantage of the present invention is that it provides a frequency conversion device that can be easily implemented because the mixers are provided in the symmetrical structure of the MOS transistors.

Additional aspect and advantages of the present general inventive concept will be set forth in part in the description which follows and, in part, will be obvious from the description, or may be learned by practice of the general inventive concept.

According to an aspect of the invention, a sub-harmonic frequency conversion device includes: a voltage controlled oscillator for generating first to eighth oscillation frequency (LO) signals having a constant phase difference; a first mixer for performing a switching operation to mix the first to fourth LO signals having a phase difference of 90° and input signals, and outputting first IF signals; and a second mixer for performing a switching operation to mix the fifth to eighth LO signals having a phase difference of 90° and the input signals, and outputting second IF signals.

According to another aspect of the present invention, the first mixer is a passive mixer.

According to a further aspect of the present invention, the second mixer is a passive mixer.

According to a still further aspect of the present invention, the first mixer includes: a first switching unit for switching on/off a positive input signal according to the first to fourth LO signals provided from the voltage controlled oscillator; and a second switching unit, connected in parallel to the first switching unit, for switching on/off a negative input signal according to the first to fourth LO signals provided from the voltage controlled oscillator.

According to a still further aspect of the present invention, the second mixer includes: a third switching unit for switching on/off a positive input signal according to the fifth to eighth LO signals provided from the voltage controlled oscillator; and a fourth switching unit, connected in parallel to the third switching unit, for switching on/off a negative input signal according to the fifth to eighth LO signals provided from the voltage controlled oscillator.

According to a still further aspect of the present invention, the first switching unit includes MOS transistors (M1 to M8); the positive input signal is applied to drains of the MOS transistors (M1, M3, M5, M7); any one of the first to fourth LO signals is applied to gates of the MOS transistors (M1, M7); an LO signal having a phase difference of 90° with respect to the LO signal applied to the gates of the MOS transistors (M1, M7) is applied to gates of the MOS transistors (M2, M6); an LO signal having a phase difference of 180° with respect to the LO signal applied to the gates of the MOS transistors (M1, M7) is applied to gates of the MOS transistors (M4, M5); an LO signal having a phase difference of 180° with respect to the LO signal applied to the gates of the MOS transistors (M2, M6) is applied to gates of the MOS transistors (M3, M8); a source of the MOS transistor (M1) is connected to a drain of the MOS transistor (M2); a source of the MOS transistor (M3) is connected to a drain of the MOS transistor (M4); a source of the MOS transistor (M5) is connected to a drain of the MOS transistor (M6); and a source of the MOS transistor (M7) is connected to a drain of the MOS transistor (M8).

According to a still further aspect of the present invention, the second switching unit includes MOS transistors (M21 to M28); the negative input signal is applied to drains of the MOS transistors (M21, M23, M25, M27); an LO signal identical to the LO signal applied to the gates of the MOS transistors (M1, M7) of the first switching unit is applied to gates of the MOS transistors (M21, M27); an LO signal having a phase difference of 90° with respect to the LO signal applied to the gates of the MOS transistors (M21, M27) is applied to gates of the MOS transistors (M26, M28); an LO signal having a phase difference of 180° with respect to the LO signal applied to the gates of the MOS transistors (M21, M27) is applied to gates of the MOS transistors (M24, M25); an LO signal having a phase difference of 180° with respect to the LO signal applied to the gates of the MOS transistors (M26, M28) is applied to gates of the MOS transistors (M22, M23); a source of the MOS transistor (M21) is connected to a drain of the MOS transistor (M22); a source of the MOS transistor (M23) is connected to a drain of the MOS transistor (M24); a source of the MOS transistor (M25) is connected to a drain of the MOS transistor (M26); and a source of the MOS transistor (M27) is connected to a drain of the MOS transistor (M28).

According to a still further aspect of the present invention, the third switching unit includes MOS transistors (M31 to M38); the positive input signal is applied to drains of the MOS transistors (M31, M33, M35, M37); any one of the fifth to eighth LO signals is applied to gates of the MOS transistors (M31, M37); an LO signal having a phase difference of 90° with respect to the LO signal applied to the gates of the MOS transistors (M31, M37) is applied to gates of the MOS transistors (M32, M36); an LO signal having a phase difference of 180° with respect to the LO signal applied to the gates of the MOS transistors (M31, M37) is applied to gates of the MOS transistors (M34, M35); an LO signal having a phase difference of 180° with respect to the LO signal applied to the gates of the MOS transistors (M32, M36) is applied to gates of the MOS transistors (M33, M38); a source of the MOS transistor (M31) is connected to a drain of the MOS transistor (M32); a source of the MOS transistor (M33) is connected to a drain of the MOS transistor (M34); a source of the MOS transistor (M35) is connected to a drain of the MOS transistor (M36); and a source of the MOS transistor (M37) is connected to a drain of the MOS transistor (M38).

According to a still further aspect of the present invention, the fourth switching unit includes MOS transistors (M41 to M48); the negative input signal is applied to drains of the MOS transistors (M41, M43, M45, M47); an LO signal identical to the LO signal applied to the gates of the MOS transistors (M41, M47) of the third switching unit is applied to gates of the MOS transistors (M41, M47); an LO signal having a phase difference of 90° with respect to the LO signal applied to the gates of the MOS transistors (M41, M47) is applied to gates of the MOS transistors (M46, M48); an LO signal having a phase difference of 180° with respect to the LO signal applied to the gates of the MOS transistors (M41, M47) is applied to gates of the MOS transistors (M44, M45); an LO signal having a phase difference of 180° with respect to the LO signal applied to the gates of the MOS transistors (M46, M48) is applied to gates of the MOS transistors (M42, M43); a source of the MOS transistor (M41) is connected to a drain of the MOS transistor (M42); a source of the MOS transistor (M43) is connected to a drain of the MOS transistor (M44); a source of the MOS transistor (M45) is connected to a drain of the MOS transistor (M46); and a source of the MOS transistor (M47) is connected to a drain of the MOS transistor (M48).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 and 2 are waveform diagram illustrating a process of generating an LO signal according to the related art;

FIG. 3 is a schematic diagram of a conventional frequency conversion device using the LO signal shown in FIG. 1 or 2;

FIG. 4 is a block diagram of a frequency conversion device according to an embodiment of the present invention;

FIG. 5 is a detailed block diagram of the frequency conversion device according to an embodiment of the present invention;

FIG. 6 is a circuit diagram of a first mixer shown in FIG. 5;

FIG. 7 is a circuit diagram of a second mixer shown in FIG. 5; and

FIGS. 8A and 8B are graphs showing a simulation result of the frequency conversion device according to the present invention.

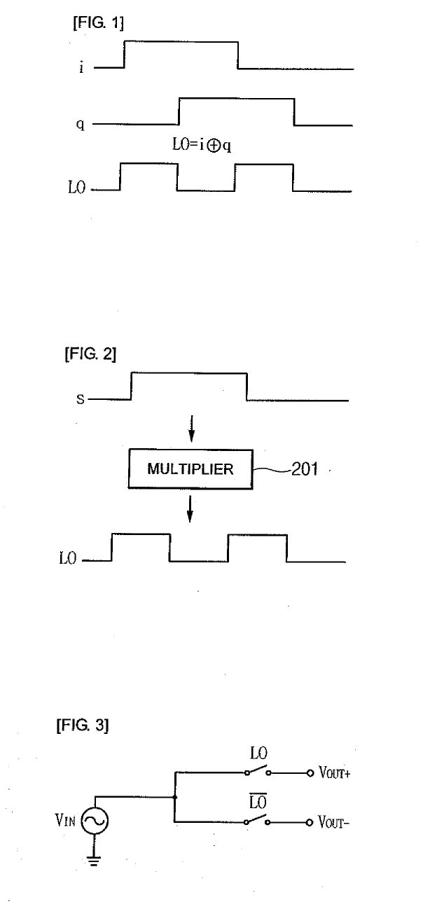

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures. In the drawings, the thicknesses of layers and regions are exaggerated for clarity.

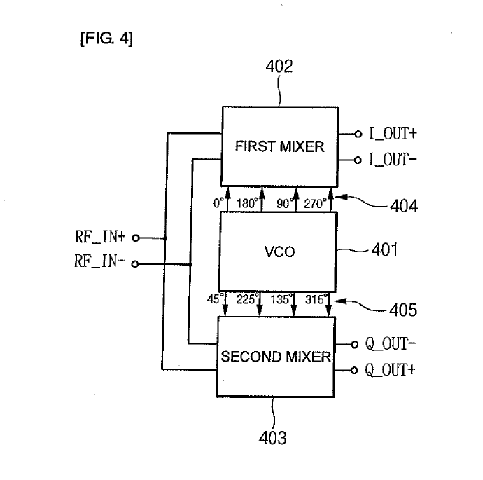

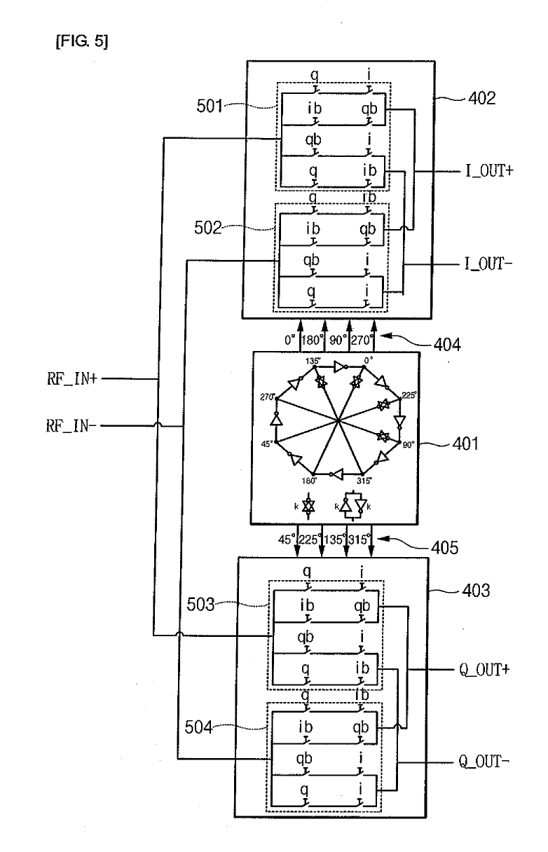

FIG. 4 is a block diagram of a frequency conversion device according to an embodiment of the present invention, and FIG. 5 is a detailed block diagram of the frequency conversion device shown in FIG. 4.

Referring to FIGS. 4 and 5, the frequency conversion device includes a VCO 401, a first mixer 402, and a second mixer 403.

In this embodiment, the frequency conversion device is implemented using a sub-harmonic scheme.

The sub-harmonic scheme uses a VCO that provides a signal with half the frequency of a signal provided in a typical frequency conversion scheme. In addition, because a frequency multiplication function is provided within a mixer, a multiplier required in the related art is unnecessary.

Because the frequency conversion device according to the present invention can use a low-frequency LO signal, a small-sized VCO can be used and the multiplier is unnecessary, thus reducing the power consumption.

The VCO 401 generates first to eighth LO signals 404 and 405 having a constant phase difference.

In this embodiment, it is assumed that the VCO 401 generates the first to eighth LO signals 404 and 405 having a phase difference of 45° to the first mixer 402 and the second mixer 403. At this point, the first to fourth LO signals 404 are the LO signals having a phase difference of 90°, i.e., a 0° LO signal, a 90° LO signal, a 180° LO signal, and a 270° signal. The fifth to eighth LO signals 405 are the LO signals having a phase difference of 90°, i.e., a 45° LO signal, a 135° LO signal, a 225° LO signal, and a 315° LO signal.

Referring to FIG. 5, the first mixer 402 includes a first switching unit 501 and a second switching unit 502. The first mixer 402 performs a switching operation to mix the first to fourth LO signals 404 and input signals RF_IN+ and RF_IN−, and outputs first IF signals I_OUT+ and I_OUT−.

That is, the first switching unit 501 switches on/off the positive input signal RF_IN+ according to the first to fourth LO signals 404 provided from the VCO 401. The second switching unit 502 is connected in parallel to the first switching unit 501. The second switching unit 502 switches on/off the negative input signal RF_IN− according to the first to fourth LO signals 404, and outputs the first IF signals I_OUT+ and I_OUT−.

The second mixer 403 includes a third switching unit 503 and a fourth switching unit 504. The second mixer 403 performs a switching operation to mix the fifth to eighth LO signals 405 and the input signals RF_IN+ and RF_IN−, and outputs second IF signals Q_OUT+ and Q_OUT−.

That is, the third switching unit 503 switches on/off the positive input signal RF_IN+according to the fifth to eighth LO signals 405 provided from the VCO 401. The fourth switching unit 504 is connected in parallel to the third switching unit 503. The fourth switching unit 504 switches on/off the negative input signal RF_IN− according to the fifth to eighth LO signals 405, and outputs the second IF signals I_OUT+ and I_OUT−.

The first IF signals I_OUT+ and I_OUT− and the second IF signals Q_OUT+ and Q_OUT− are also called an in-phase signal and a quadrature-phase signal, respectively. The first IF signals I_OUT+ and I_OUT−and the second IF signals Q_OUT+ and Q_OUT− have a phase difference of 90° by the on/off switching operations of the first to fourth switching units 501 to 504.

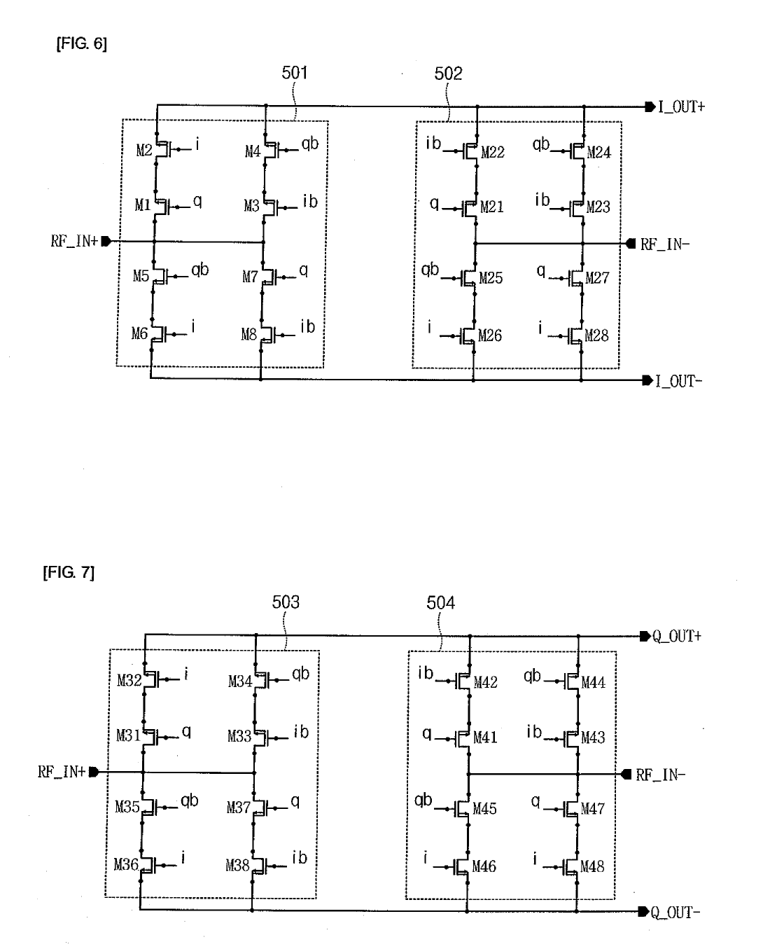

FIGS. 6 and 7 are circuit diagrams of the first mixer and the second mixer shown in FIG. 5. The first to fourth switching units 501 to 504 will be described in detail with reference to FIGS. 6 and 7.

Referring to FIG. 6, the first switching unit 501 of the first mixer 402 includes MOS transistors M1 to M8.

The positive input signal RF_IN+ is applied to drains of the MOS transistors M1, M3, M5 and M7, and one LO signal q of the first to fourth LO signals are applied to gates of the MOS transistors M1 and M7. In this embodiment, it is assumed that the LO signal having a phase of 0° is applied to the gates of the MOS transistors M1 and M7.

In addition, a 90° LO signal i having a phase difference of 90° with respect to the LO signal q applied to the gates of the MOS transistors M1 and M7 is applied to gates of the MOS transistors M2 and M6. A 180° LO signal qb having a phase difference of 180° with respect to the LO signal q applied to the gates of the MOS transistors M1 and M7 is applied to gates of the MOS transistors M4 and M5. A 270° LO signal ib having a phase difference of 180° with respect to the LO signal i applied to the gates of the MOS transistors M2 and M6 is applied to gates of the MOS transistors M3 and M8.

A source of the MOS transistor M1 is connected to a drain of the MOS transistor M2. A source of the MOS transistor M3 is connected to a drain of the MOS transistor M4. A source of the MOS transistor M5 is connected to a drain of the MOS transistor M6. A source of the MOS transistor M7 is connected to a drain of the MOS transistor M8.

The second switching unit 502 of the first mixer 402 includes MOS transistors M21 to M28.

The negative input signal RF_IN− is applied to drains of the MOS transistors M21, M23, M25 and M27. The LO signal q applied to the gates of the MOS transistors M1 to M7 of the first switching unit 501 is applied to gates of the MOS transistors M21 and M27. The 90° LO signal i having a phase difference of 90° with respect to the LO signal q applied to the gates of the MOS transistors M21 and M27 is applied to gates of the MOS transistors M26 and M28.

The 180° LO signal qb having a phase difference of 180° with respect to the LO signal q applied to the gates of the MOS transistors M21 and M27 is applied to gates of the MOS transistors M24 and M25. The 270° LO signal ib having a phase difference of 180° with respect to the LO signal i applied to the gates of the MOS transistors M26 and M28 is applied to gates of the MOS transistors M22 and M23.

In addition, a source of the MOS transistor M21 is connected to a drain of the MOS transistor M22. A source of the MOS transistor M23 is connected to a drain of the MOS transistor M24. A source of the MOS transistor M25 is connected to a drain of the MOS transistor M26. A source of the MOS transistor M27 is connected to a drain of the MOS transistor M28.

Referring to FIG. 7, the third switching unit 503 of the second mixer 403 includes MOS transistors M31 to M38.

The positive input signal RF_IN+ is applied to drains of the MOS transistors M31, M33, M35 and M37, and one LO signal q of the fifth to eighth LO signals are applied to gates of the MOS transistors M31 and M37. In this embodiment, it is assumed that the LO signal having a phase of 45° is applied to the gates of the MOS transistors M31 and M37.

In addition, a 135° LO signal i having a phase difference of 90° with respect to the LO signal q applied to the gates of the MOS transistors M31 and M37 is applied to gates of the MOS transistors M32 and M36. A 225° LO signal qb having a phase difference of 180° with respect to the LO signal q applied to the gates of the MOS transistors M31 and M37 is applied to gates of the MOS transistors M34 and M35. A 315° LO signal ib having a phase difference of 180° with respect to the LO signal i applied to the gates of the MOS transistors M32 and M36 is applied to gates of the MOS transistors M33 and M38.

A source of the MOS transistor M31 is connected to a drain of the MOS transistor M32. A source of the MOS transistor M33 is connected to a drain of the MOS transistor M34. A source of the MOS transistor M35 is connected to a drain of the MOS transistor M36. A source of the MOS transistor M37 is connected to a drain of the MOS transistor M38.

The fourth switching unit 504 of the second mixer 403 includes MOS transistors M41 to M48.

The negative input signal RF_IN− is applied to drains of the MOS transistors M41, M43, M45 and M47. The 45° LO signal q applied to the gates of the MOS transistors M31 to M37 of the third switching unit 503 is applied to gates of the MOS transistors M41 and M47. The 135° LO signal i having a phase difference of 90° with respect to the LO signal q applied to the gates of the MOS transistors M41 and M47 is applied to gates of the MOS transistors M46 and M48.

The 225° LO signal qb having a phase difference of 180° with respect to the LO signal q applied to the gates of the MOS transistors M41 and M47 is applied to gates of the MOS transistors M44 and M45. The 315° LO signal ib having a phase difference of 180° with respect to the LO signal i applied to the gates of the MOS transistors M46 and M48 is applied to gates of the MOS transistors M42 and M43.

In addition, a source of the MOS transistor M41 is connected to a drain of the MOS transistor M42. A source of the MOS transistor M43 is connected to a drain of the MOS transistor M44. A source of the MOS transistor M45 is connected to a drain of the MOS transistor M46. A source of the MOS transistor M47 is connected to a drain of the MOS transistor M48.

As shown in FIGS. 6 and 7, the circuit configuration of the first mixer 402 and the second mixer 403 can be easily implemented because they are configured with the symmetrical structure using the same number of the MOS transistors.

Meanwhile, the first mixer 402 and the second mixer 403 are implemented in a passive mixer form. Unlike an active mixer, the passive mixer constantly maintains a gain between the input signal and the frequency-converted IF signal.

The gain can be calculated using Equation (1) below, and a down-conversion device has a gain of about −2 dB.

$$G = 10 log \frac{Vin}{Vout} \qquad ( 1 )$$

where G represents a gain, Vin represents a peak voltage when the input signal is converted into a voltage, and Vout represents a peak voltage when the IF signal is converted into a voltage.

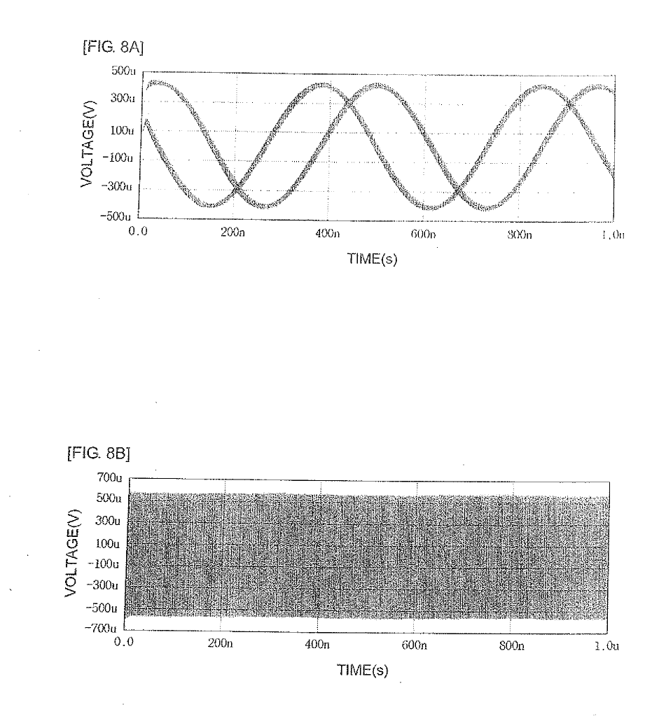

FIGS. 8A and 8B are graphs showing a simulation result of the frequency conversion device according to the present invention. Specifically, FIG. 8A is a waveform diagram of the applied input signal, and FIG. 8B is a waveform diagram of the IF signal according to the input signal of FIG. 8A.

FIGS. 8A and 8B show the simulation results of the down-conversion device including a ring VCO generating eight LO signals with a frequency of 1.2 GHz and mixers implemented with NMOS transistors having a width of 20 μm and a length of 0.18 μm.

As can be seen from FIGS. 8A and 8B, the peak voltage when the applied input signal is converted into a voltage is 800 μV, and the peak voltage when the outputted IF signal is converted into a voltage is 1,100 μV. When the peak voltage substitutes into Equation (1), the gain is −2 dB.

Therefore, the frequency conversion device using the sub-harmonic scheme and the symmetrical structure of the MOS transistors according to the present invention has the same gain as the typical down-conversion device using the passive mixer.

According to the present invention, the frequency conversion device can use the low-frequency LO signal because it is implemented using the sub-harmonic scheme. Therefore, the small-sized VCO can be used and the power consumption can be reduced because the multiplier is unnecessary.

In addition, the circuit configuration can be easily implemented because the mixers are provided in the symmetrical structure of the MOS transistors.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A sub-harmonic frequency conversion device comprising:
a voltage controlled oscillator for generating first to eighth oscillation frequency (LO) signals having a constant phase difference;
a first mixer for performing a switching operation to mix the first to fourth LO signals having a phase difference of 90° and input signals, and outputting first IF signals; and
a second mixer for performing a switching operation to mix the fifth to eighth LO signals having a phase difference of 90° and the input signals, and outputting second IF signals.

2. The sub-harmonic frequency conversion device according to claim 1,
wherein the first mixer is a passive mixer.

3. The sub-harmonic frequency conversion device according to claim 1,
wherein the second mixer is a passive mixer.

4. The sub-harmonic frequency conversion device according to claim 2,
wherein the first mixer includes:
a first switching unit for switching on/off a positive input signal according to the first to fourth LO signals provided from the voltage controlled oscillator; and
a second switching unit, connected in parallel to the first switching unit, for switching on/off a negative input signal according to the first to fourth LO signals provided from the voltage controlled oscillator.

5. The sub-harmonic frequency conversion device according to claim 3,
wherein the second mixer includes:
a third switching unit for switching on/off a positive input signal according to the fifth to eighth LO signals provided from the voltage controlled oscillator; and
a fourth switching unit, connected in parallel to the third switching unit, for switching on/off a negative input signal according to the fifth to eighth LO signals provided from the voltage controlled oscillator.

6. The sub-harmonic frequency conversion device according to claim 4,
wherein the first switching unit includes MOS transistors (M1 to M8);
the positive input signal is applied to drains of the MOS transistors (M1, M3, M5, M7);
any one of the first to fourth LO signals is applied to gates of the MOS transistors (M1, M7);
an LO signal having a phase difference of 90° with respect to the LO signal applied to the gates of the MOS transistors (M1, M7) is applied to gates of the MOS transistors (M2, M6);
an LO signal having a phase difference of 180° with respect to the LO signal applied to the gates of the MOS transistors (M1, M7) is applied to gates of the MOS transistors (M4, M5);
an LO signal having a phase difference of 180° with respect to the LO signal applied to the gates of the MOS transistors (M2, M6) is applied to gates of the MOS transistors (M3, M8);
a source of the MOS transistor (M1) is connected to a drain of the MOS transistor (M2);
a source of the MOS transistor (M3) is connected to a drain of the MOS transistor (M4);
a source of the MOS transistor (M5) is connected to a drain of the MOS transistor (M6); and
a source of the MOS transistor (M7) is connected to a drain of the MOS transistor (M8).

7. The sub-carrier frequency conversion device according to claim 6,
wherein the second switching unit includes MOS transistors (M21 to M28);
the negative input signal is applied to drains of the MOS transistors (M21, M23, M25, M27);
an LO signal identical to the LO signal applied to the gates of the MOS transistors (M1, M7) of the first switching unit is applied to gates of the MOS transistors (M21, M27);
an LO signal having a phase difference of 90° with respect to the LO signal applied to the gates of the MOS transistors (M21, M27) is applied to gates of the MOS transistors (M26, M28);
an LO signal having a phase difference of 180° with respect to the LO signal applied to the gates of the MOS transistors (M21, M27) is applied to gates of the MOS transistors (M24, M25);
an LO signal having a phase difference of 180° with respect to the LO signal applied to the gates of the MOS transistors (M26, M28) is applied to gates of the MOS transistors (M22, M23);
a source of the MOS transistor (M21) is connected to a drain of the MOS transistor (M22);
a source of the MOS transistor (M23) is connected to a drain of the MOS transistor (M24);
a source of the MOS transistor (M25) is connected to a drain of the MOS transistor (M26); and
a source of the MOS transistor (M27) is connected to a drain of the MOS transistor (M28).

8. The sub-harmonic frequency conversion device according to claim 5,
wherein the third switching unit includes MOS transistors (M31 to M38);
the positive input signal is applied to drains of the MOS transistors (M31, M33, M35, M37);
any one of the fifth to eighth LO signals is applied to gates of the MOS transistors (M31, M37);
an LO signal having a phase difference of 90° with respect to the LO signal applied to the gates of the MOS transistors (M31, M37) is applied to gates of the MOS transistors (M32, M36);
an LO signal having a phase difference of 180° with respect to the LO signal applied to the gates of the MOS transistors (M31, M37) is applied to gates of the MOS transistors (M34, M35);
an LO signal having a phase difference of 180° with respect to the LO signal applied to the gates of the MOS transistors (M32, M36) is applied to gates of the MOS transistors (M33, M38);
a source of the MOS transistor (M31) is connected to a drain of the MOS transistor (M32);
a source of the MOS transistor (M33) is connected to a drain of the MOS transistor (M34);
a source of the MOS transistor (M35) is connected to a drain of the MOS transistor (M36); and
a source of the MOS transistor (M37) is connected to a drain of the MOS transistor (M38).

9. The sub-carrier frequency conversion device according to claim 8,
wherein the fourth switching unit includes MOS transistors (M41 to M48);
the negative input signal is applied to drains of the MOS transistors (M41, M43, M45, M47);
an LO signal identical to the LO signal applied to the gates of the MOS transistors (M41, M47) of the third switching unit is applied to gates of the MOS transistors (M41, M47);
an LO signal having a phase difference of 90° with respect to the LO signal applied to the gates of the MOS transistors (M41, M47) is applied to gates of the MOS transistors (M46, M48);
an LO signal having a phase difference of 180° with respect to the LO signal applied to the gates of the MOS transistors (M41, M47) is applied to gates of the MOS transistors (M44, M45);
an LO signal having a phase difference of 180° with respect to the LO signal applied to the gates of the MOS transistors (M46, M48) is applied to gates of the MOS transistors (M42, M43);
a source of the MOS transistor (M41) is connected to a drain of the MOS transistor (M42);
a source of the MOS transistor (M43) is connected to a drain of the MOS transistor (M44);
a source of the MOS transistor (M45) is connected to a drain of the MOS transistor (M46); and
a source of the MOS transistor (M47) is connected to a drain of the MOS transistor (M48).
